(19) United States
(12) Patent Application Publication
(10) Pub. No.: US 2018/0308130 A1
(43) Pub. Date: Oct. 25, 2018

(54) System and Method for UAV Based Mobile Messaging

(71) Applicants: Usman Hafeez, Chicago, IL (US); David Mauer, Chicago, IL (US)

(72) Inventors: Usman Hafeez, Chicago, IL (US); David Mauer, Chicago, IL (US)

(21) Appl. No.: 15/491,467

(22) Filed: Apr. 19, 2017

(51) Int. Cl. G06Q 30/02; B64C 39/02; G08G 5/00; G09F 21/10

(52) U.S. Cl. CPC G06Q 30/0265; B64C 39/024; G08G 5/0069; B64C 2201/126; G06Q 30/0261; G06Q 30/0269; G09F 21/10

(57) ABSTRACT

A method for executing a flight mission by one or more unmanned aerial vehicles is disclosed. The method comprises receiving, from an unmanned aerial vehicle, a data stream containing audience location information; analyzing the audience location information to determine the presence of one or more people; receiving an instruction setting a predetermined number of people; determining whether a number of people at the location is equal to or greater than the predetermined number of people; retrieving a message data file; transmitting the message data file to the unmanned aerial vehicle; and displaying, by the unmanned aerial vehicle, the message data file on a display screen integral to the first unmanned aerial vehicle. In other embodiments, individuals may present visual information to the UAV. The system then selects a response based on the visual information presented to the UAV.

### FIELD OF THE INVENTION

This invention pertains generally to unmanned aerial vehicles and more particularly to a system and method for transmitting and displaying messages by means of unmanned aerial vehicles.

### BACKGROUND OF INVENTION

The use of Unmanned Aerial Vehicles (UAVs), otherwise known as drones, is a growing market and their use for multiple purposes is expected to grow exponentially within the next few years. UAVs can be used for any number of purposes. UAVs can fly over parts of land to give aerial views of land for planning purposes or be used for recreational purposes.

The use of a system of drones connected to a central computer system, which is used to plan and control the operation of the system of drones has been disclosed and taught by patents owned by the current inventors—U.S. Pat. No. 9,454,157, the disclosure of which is hereby fully incorporated by reference, and U.S. Pat. No. 9,454,907, the disclosure of which is hereby fully incorporated by reference.

In addition, the use of electronic message boards, aerial banners and billboards is well known as well. Aerial Banners, billboards or electronic message boards can be utilized to present information to people in public areas, such as sporting arenas, on buildings, or along highways. However, there is a limitation with the current art for billboards and electric message boards due to the stationary nature of the billboards and message boards. People must plan ahead of time to determine an optimal location where the billboard will be viewed by people. This is an inefficient system because there is no guarantee that the message on the billboard will be viewed by people. Also, the message on the billboard may be viewed by people but there is no guarantee that the individuals viewing the message are a part of the message's target audience. For aerial banners and advertisements, such as blimps, and helicopter or plane based banners, it is difficult to determine who is viewing the advertisements, and it takes pre-planning to have an aerial based advertisements which does not allow for changes to location or advertisements based on viewers data.

What is needed is a system and method for utilizing UAVs to correct the deficiencies of standard billboards, aerial advertisements and electronic message boards. What is needed is a system and method for utilizing UAVs to determine locations of individuals for the presentation of messages and to determine the demographics of a particular group of people for the purposes of determining a number of UAVs to send to a specific location and particular message to display by the drones.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention is directed toward a computer implemented method for executing a flight mission by one or more unmanned aerial vehicles. The method is performed on a computer system comprising two or more microprocessors and two or more nonvolatile memory units wherein at least one of the two or more microprocessors and one of the two or more nonvolatile memory units is integral to an unmanned aerial vehicle further comprising a flight means and a display screen. The two or more nonvolatile memory units storing instructions which, when executed by the two or more microprocessors, cause the computer system to perform operations comprising receiving, from a first unmanned aerial vehicle at an audience location, a data stream containing audience location information; analyzing the audience location information to determine the presence of one or more people at the audience location; receiving an instruction setting a predetermined number of people; determining whether a number of people at the location is equal to or greater than the predetermined number of people; retrieving a message data file from a database; transmitting the message data file to the first unmanned aerial vehicle; and displaying, by the first unmanned aerial vehicle, the message data file on a display screen integral to the first unmanned aerial vehicle.

The method may further comprise determining demographic information of one or more people at the location. In another embodiment the method further comprises determining an appropriate second message file based on the demographic information; retrieving a second message data file from the database; transmitting the second message data file to the first unmanned aerial vehicle; and displaying, by the first unmanned aerial vehicle, the second message data file on a display screen integral to the first unmanned aerial vehicle.

The method may further comprise performing a scanning method on one or more people during a period of time. The scanning method is selected from a group consisting of: taking a picture of one or more people with a camera integral to the first unmanned aerial vehicle; detecting motion within a predetermined distance of the first unmanned aerial vehicle by means of a motion sensor integral to the first unmanned aerial vehicle; detecting body heat of one or more people with an infrared sensor integral to the first unmanned aerial vehicle; and creating a virtual geographic boundary a predetermined distance from the first unmanned aerial vehicle and detecting the presence of one or more location-aware devices within the virtual geographic boundary.

The method may further comprise determining one or more metrics for a message displayed by the first unmanned aerial vehicle, wherein the one or more metrics is selected from a group comprising: a number of people viewing the first unmanned aerial vehicle, a gender of one or more people viewing the first unmanned aerial vehicle, an age of one or more people viewing the first unmanned aerial vehicle, an age range of two or more people viewing the first unmanned aerial vehicle, and a time period during which a message is displayed on the first unmanned aerial vehicle.

The method may further comprise receiving a visual input from a person at the audience location; creating a visual input data file; and transmitting the visual input data file from the first unmanned aerial vehicle to a server computer. The method may further comprise broadcasting an audio file through a speaker integral to the first unmanned aerial vehicle.

The method may further comprise scanning, with a camera integral to the first unmanned aerial vehicle, at least a portion of a face of a person; creating a facial image file; comparing the facial image file to a set of previously stored reference files, wherein each of the reference files comprises facial characteristic information of one or more people; and determining a match between the facial image file and the reference file. Additionally, the method may further comprise determining an appropriate second message file based on information contained in a reference file which matches the facial image file; retrieving a second message data file from the database; transmitting the second message data file to the first unmanned aerial vehicle; and displaying, by the first unmanned aerial vehicle, the second message data file on a display screen integral to the first unmanned aerial vehicle.

The method may further comprise determining an appropriate number of unmanned aerial vehicles to display the message data file to a number of people at the audience location; determining a location of one or more second unmanned aerial vehicles; respectively determining one or more geographic flight paths for the one or more second unmanned aerial vehicles and transmitting flight path instructions to the one or more second unmanned aerial vehicles. Each of the one or more geographic flight paths includes a starting point, the starting point being a location of a second unmanned aerial vehicle, and a geographic ending point, the geographic ending point being the audience location.

Alternatively the invention is directed toward a computer implemented method of: scanning, by an unmanned aerial vehicle, one or more people at an audience location; creating, by the unmanned aerial vehicle, a scan data file; transmitting, by the unmanned aerial vehicle, the scan data file to a server computer; receiving, by the server computer, the scan data file; analyzing information contained in the scan data file; selecting, by the server computer, a message data file from a database; transmitting, by the server computer, the message data file to the unmanned aerial vehicle; and displaying, by the first unmanned aerial vehicle, the message data file on a display screen integral to the first unmanned aerial vehicle.

The method may further comprise determining demographic information of one or more people at the audience location. The method may further comprise determining an appropriate second message file based on the demographic information; retrieving a second message data file from the database; transmitting the second message data file to the unmanned aerial vehicle; and displaying, by the unmanned aerial vehicle, the second message data file on a display screen integral to the unmanned aerial vehicle.

The method may further comprise broadcasting an audio file through a speaker integral to the unmanned aerial vehicle. Additionally, the step of scanning is selected from a group consisting of: taking a picture with a camera integral to the unmanned aerial vehicle; detecting motion within a predetermined distance of the first unmanned aerial vehicle by means of a motion sensor integral to the unmanned aerial vehicle; detecting body heat of one or more people with an infrared sensor integral to the unmanned aerial vehicle; and creating a virtual geographic boundary a predetermined distance from the unmanned aerial vehicle and detecting the presence of one or more location-aware devices within the virtual geographic boundary.

The method may further comprise determining one or more metrics for a message displayed by the unmanned aerial vehicle, wherein the one or more metrics is selected from a group comprising: a number of people viewing the first unmanned aerial vehicle, a gender of one or more people viewing the first unmanned aerial vehicle, an age of one or more people viewing the first unmanned aerial vehicle, an age range of two or more people viewing the first unmanned aerial vehicle, and a time period during which a message is displayed on the first unmanned aerial vehicle.

Alternatively, the invention is directed toward a method of receiving, by an unmanned aerial vehicle, visual input information from one or more people; creating, by the unmanned aerial vehicle, an image data file; transmitting, by the unmanned aerial vehicle, the image data file to a server computer; analyzing, by the server computer, the image data file to determine the visual input information; determining, by the server computer, a predetermined response message to the visual input information; selecting, by the server computer, a message data file from a database; transmitting, by the server computer, the message data file to the unmanned aerial vehicle; and displaying, by the first unmanned aerial vehicle, the message data file on a display screen integral to the first unmanned aerial vehicle.

The method may further comprise determining, by the server computer, that the visual input information comprises a QR code. Alternatively, the method may further comprise determining, by the server computer, that the visual input information comprises at least a portion of a person's face. Additionally, the method may further comprise broadcasting an audio file through a speaker integral to the unmanned aerial vehicle.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a schematic view of the system of the invention;

FIG. 2 is a schematic view of a UAV;

FIG. 3 is a schematic view of a charging station;

FIG. 4A is a view of a plurality of sensor encasements;

FIG. 4B is a view of a plurality of sensor encasements;

FIG. 5 is an illustration of a UAV scanning an audience;

FIG. 6 is an illustration of a UAV displaying a message to an audience;

FIG. 7 is an illustration of a map showing flight paths of UAVs;

FIG. 8 is a schematic showing the method of the invention;

FIG. 9 is a schematic showing the method of the invention;

FIG. 10 is a schematic showing the method of the invention;

FIG. 11 is a schematic showing the method of the invention;

FIG. 12 is a schematic showing the method of the invention;

FIG. 13 is a schematic showing the method of the invention;

FIG. 14 is a schematic showing the method of the invention;

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

As used in this application, the terms “component”, “module”, “system”, “interface”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component.

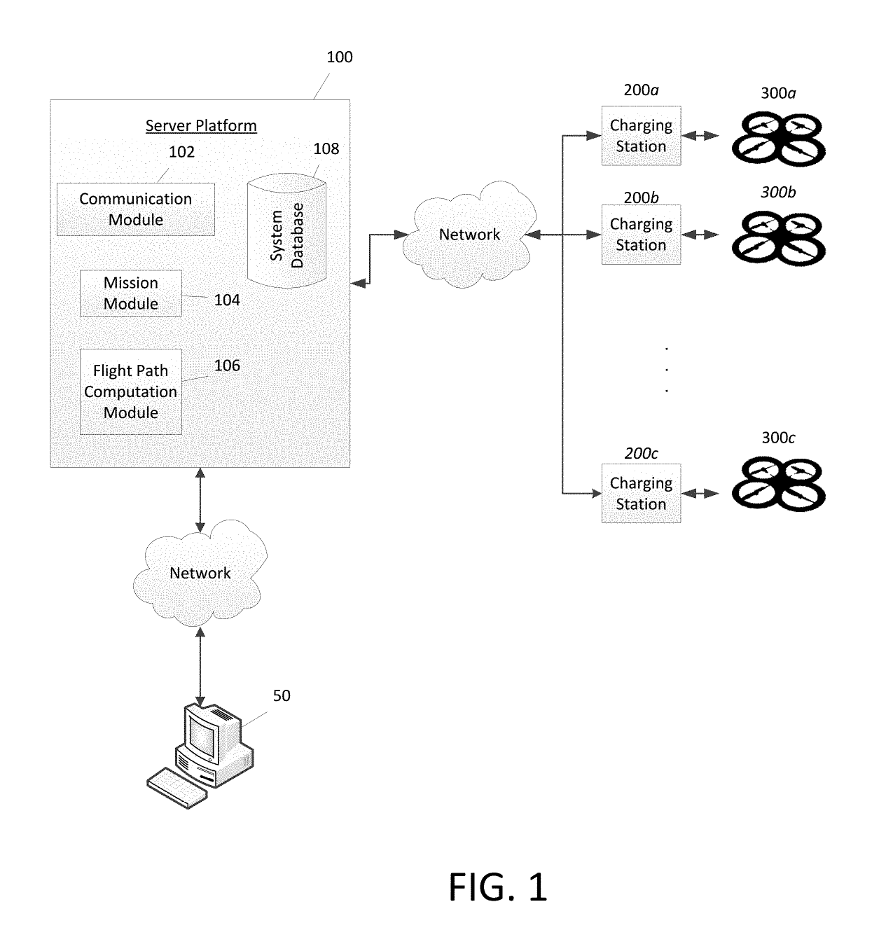

The invention is directed toward a system and method for managing missions being executed by UAVs. Referring to FIG. 1, the system of the invention is displayed. The system comprises a server computer 100 connected to a plurality of charging stations 200a, 200b, 200c. Each charging station 200a, 200b, 200c is configured to receive one or more UAVs 300a, 300b, 300c. A single charging station 200 may receive a single UAV 300. In other embodiments a single charging station 200 may receive multiple UAVs 300 simultaneously. A UAV 300 may land on a charging station 200 to recharge the battery of the UAV 300. The UAV 300 may also communicate with the server computer 100 through the charging station 200. The server computer 100 can send mission details and executable instructions to the UAV 300. In other embodiments, each UAV 300a, 300b, 300c may also communicate directly with the server computer 100. The system may comprise any number of charging stations 200 and any number of UAVs 300.

The server computer 100 is communicatively coupled to a database 108. The database 108 stores all information about every UAV 300a, 300b, 300c connected to the server computer 100. The database 108 may store any relevant information pertaining to the system such as UAV location, missions being performed by each UAV, mission history, battery power levels of each UAV, and time for execution of any mission. In addition the database 108 may store messages for transferring to UAVs to display. The messages stored on the database 108 may be any type of messages. The messages stored on the database 108 may be text messages, video messages, audio messages, audiovisual messages, or any other type of content. The messages may store any type of content, such as advertising message, public service announcement, weather warning, time, temperature, commercial, video, or any other type of media content.

Users may interact with the server computer 100 directly or through a client device 50. The client device 50 may be any type of computerized device utilized by a user to communicate with the server computer 100. The client device 50 may be a desktop computer, a laptop computer, a tablet computer, a wireless cellular phone, or any other type of communicative computerized device.

The server computer 100 stores and executes a series of software modules, including a communication module 102, a mission module 104, a flight path computation module 106, and a message module 110. The communication module 102 determines the location of a UAV 300 and transmits instructions to be executed by a UAV 300. Each UAV 300a, 300b, 300c has a specific communication ID number which permits the communication module 102 to track and send specific instructions to each respective UAV 300a, 300b, 300c. The communication ID number can be any number assigned to each respective UAV 300a, 300b, 300c that permits the system to independently identify each each respective UAV 300a, 300b, 300c, such as a unique IP address. The communication module 102 may communicate with a UAV 300 through a charging station 200 or directly through a network connection, such as the internet or a cellular connection.

The mission module 104 computes and tracks each mission executed by each UAV 300. When a user assigns a mission to the system to be executed, the mission module 104 determines the start point and end point of the mission and which respective UAVs 300a, 300b, 300c are needed to execute the mission. The mission module 104 then determines the specific instructions to send to the respective UAVs 300a, 300b, 300c and assigns the mission to the proper UAVs 300a, 300b, 300c.

The flight path computation module 106 determines the proper flight path for each UAV 300a, 300b, 300c to maximize efficiency in time and battery life for each UAV 300a, 300b, 300c. The flight path computation module 106 determines the proper flight path from the starting point to the end point of the mission. The flight path computation module 106 determines the charging stations 200a, 200b, 200c which are along the proper flight path which may be used by the specific UAVs executing the mission.

The message module 110 tracks the messages displayed by the respective UAVs 300a, 300b, 300c, determines the proper message to send to a UAV 300, tracks the analytics of any message displayed by a UAV, and otherwise tracks and manages the usage, storage, and operations of all messages sent through the system.

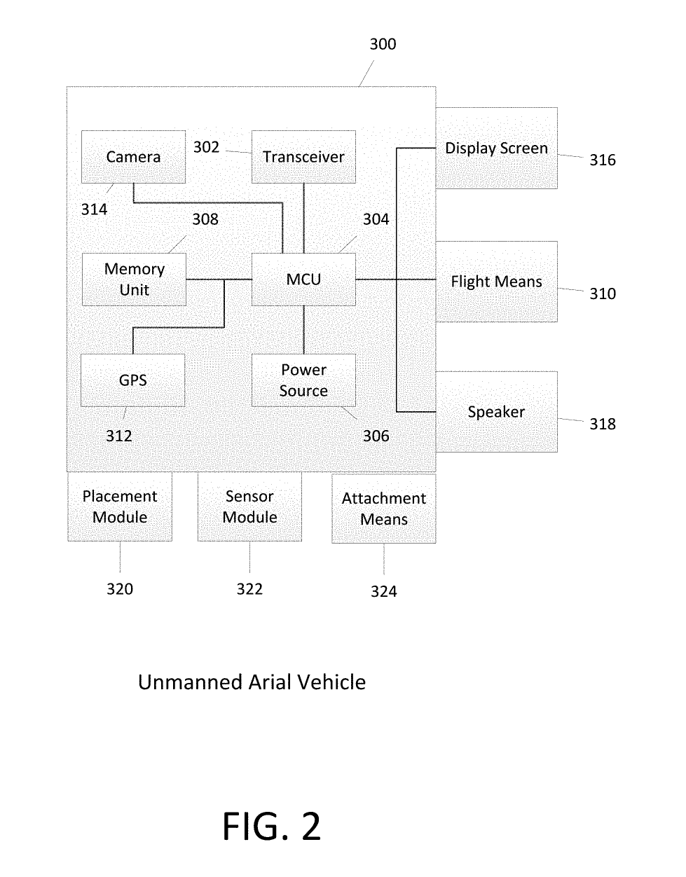

Referring to FIG. 2, a standard embodiment of the UAV 300 is displayed. The UAV 300 has a central processing unit 304 which executes the instructions and missions transferred to the UAV 300. The central processing unit 304 is attached to a transceiver 302, a memory unit 308, a power source 306, a GPS unit 312, a camera 314, a display screen 316, a speaker 318, a placement module 320, a sensor module 322, and a flight means 310. The memory unit 308 is any type of data storage component and may store information about the about current missions or objectives being executed by the UAV 300, the location of the nearest communication hub 120 or charging station, as well as any other relevant information. Additionally the memory unit 308 may be utilized to buffer data streams received from the server computer 100, communication hub 120, or charging station. The transceiver 302 sends and receives information to and from the server computer 100, communication hub 120, or charging station. In other embodiments the transceiver 302 may send and receive information through a wireless cellular network. The system may transmit mission data through the wireless cellular network. The information received in the transceiver 308 from the wireless cellular network may also permit the UAV 300 to triangulate its position based on signals received from cellular phone towers. The GPS unit 312 determines the global position of the UAV 300. The GPS unit 312 permits the server computer 100 to determine the location of the UAV 300 before and during its flight path to calculate the most efficient flight path or variations of the flight path. The power source 306 may be any type of battery configured to meet the energy needs of the UAV 300 to ensure power for flight of the UAV 300 and operation of the central processing unit 306, the transceiver 302, the memory unit 308, and the GPS unit 312. The power source 306 may further comprise a charging means. The charging means is any component or circuitry configured to receive energy to resupply energy to the power source 306.

The sensor module 322 of the UAV 300 is a means to carry single or multiple sensors by the UAV 300. The sensor module 322 consists of sensors, a means to carry these sensors, a means to have the appropriate sensor ready for the UAV 300 to place. The sensor module 322 may comprise of a mechanism that carries multiple sensors and, based on the commands sent by the MCU 304, selects the appropriate sensors to be made ready for placement by the placement module 320. In other embodiments the sensor module 322 may utilize sensors directly such that the UAV 300 may take measurements directly while in flight without the placement of a sensor. The measurements taken by the sensor module may include motion detection, light level detection, weather or precipitation detection, wind detection, or any other measurement of an attribute in the vicinity of the UAV 300 during flight or after landing of the UAV 300.

The placement module 320 of the UAV 300 is a means to place the sensors that are carried by the sensor module 322. The placement module 320 may comprise of a screw or another type of rod that, by commands sent by the MCU 304, extends and retracts, placing the sensors fed by the sensor module 322. The placement module 320 may also comprise of a gas cylinder, or another means of projecting sensors, that pushes the sensors fed by the sensor module 322 to their appropriate placement location.

The flight means 310 of the UAV 300 is any type of motorized component or multiple components configured to generate sufficient lift to get the UAV 300 into flight. The flight means 310 may comprise one or more horizontal propellers. In other embodiments, the flight means 310 may comprise one or more set of wings and a vertical propeller. In other embodiments the flight means 310 may comprise one or more set of wings and a combustible jet engine.

The UAV 300 further comprises a camera 314. The camera 314 may be a still photograph camera or a video camera. The camera 314 takes visual images from the point of view of the UAV and feeds information back to the server computer 100, communication hub 120, and/or client computer 110. The UAV 300 further comprises a display screen 316 and a speaker 318. The display screen 316 is any type of electronic display screen, such as LCD, LED, projector, OLED, or any other type of component configured to create a visual display. The speaker 318 is any type of component configured to play and broadcast an audio file to be heard by individuals in the vicinity of the UAV 300.

The UAV 300 further comprises an attachment means 324. The attachment means 324 is any type of physical or electrical means by which the UAV 300 may mount itself on a structure to conserve energy stored in the power source 306 since the flight means 310 would not need to be operated. The attachment means 324 may be a mechanical adhesion, such as a clamp, screw, rope, bolt, Velcro, suction cups, glue, adhesive, temporary adhesive, or any other mechanical means to attach the UAV 300 to a physical structure. The attachment means 324 may be a chemical adhesion, such as the UAV 300 mixing two separately stored chemicals together to create an adhesive on a portion of the surface of the UAV 300. The adhesive is then used to attach the UAV 300 to a structure at a desired location. The attachment means 324 may also be through magnetic adhesion. In this embodiment the UAV 300 utilizes an electromagnet or magnet to attach the UAV 300 to a metal structure at a desire location. The attachment means 324 may also be electrostatic adhesion, which uses Gecko type adhesion to adhere the UAV 300 to a structure. The electrostatic adhesion uses a combination of embedded electrodes and directional dry adhesives to create van der Waals forces to adhere the UAV 300 to a structure.

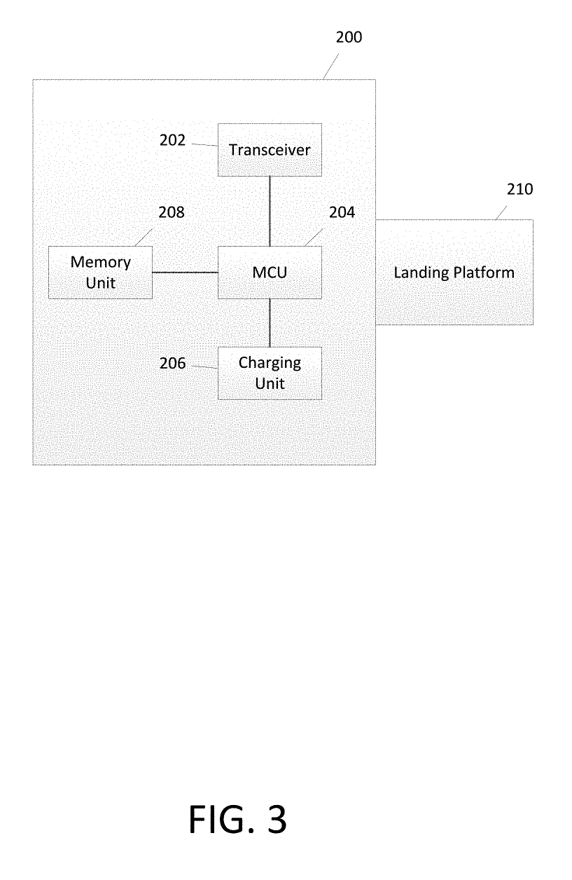

The charging station 200 may be realized in any number of embodiments. Referring to FIG. 3 the preferred embodiment of the charging station 200 is displayed. In this embodiment the charging station 200 comprises a central processor 204 connected to a memory unit 208, a transceiver 202, and a charging unit 206. The central processor 204 performs all processing functions required by the charging station 200. The memory unit 208 is any type of data storage component and may store information about the UAVs currently charging at the charging station 200 or information about current missions or objectives, as well as any other relevant information. Additionally the memory unit 208 may be utilized to buffer data streams received from the server computer 100 or UAV 300. The transceiver 202 sends and receives information to and from the server computer 100 or UAV 300. In the preferred embodiment the transceiver 202 wirelessly transmits and receives information to and from the server computer 100. In other embodiments the charging station 200 may have a direct wire connection with the server computer 100 for transmitting and receiving information. In other embodiments the charging station 200 may establish a direct wired connection link with a UAV 300 that is being charged at the charging station 200. The charging unit 206 is a component utilized to recharge the battery of the UAV 300 stationed at the charging station 200. The charging unit 206 may be directly connected to the UAV 300 through a connection port, plug, or other structure to permit the flow of electricity from the charging station 200 to the UAV 300. In other embodiments the charging unit 206 may charge the UAV 300 through inductive charging without a direct connection. The charging unit 206 may be presented in a series of embodiments. In one embodiment the charging unit 206 is directly connected to an electrical grid and directly charges the UAV 300. In another embodiment, the charging unit 206 may be comprised of a battery, or a capacitor, and a power generation means, such as a solar panel. In this embodiment the charging unit 206 generates and stores electrical energy until it is needed by a UAV 300. At that point in time, the battery discharges and charges the UAV 300. The charging station also comprises a landing platform 210. The landing platform 210 provides a surface for receiving the UAV 300. The landing platform 210 may be an extension from the charging station 200. In other embodiments the landing platform 210 may be the housing of the charging station 200 itself.

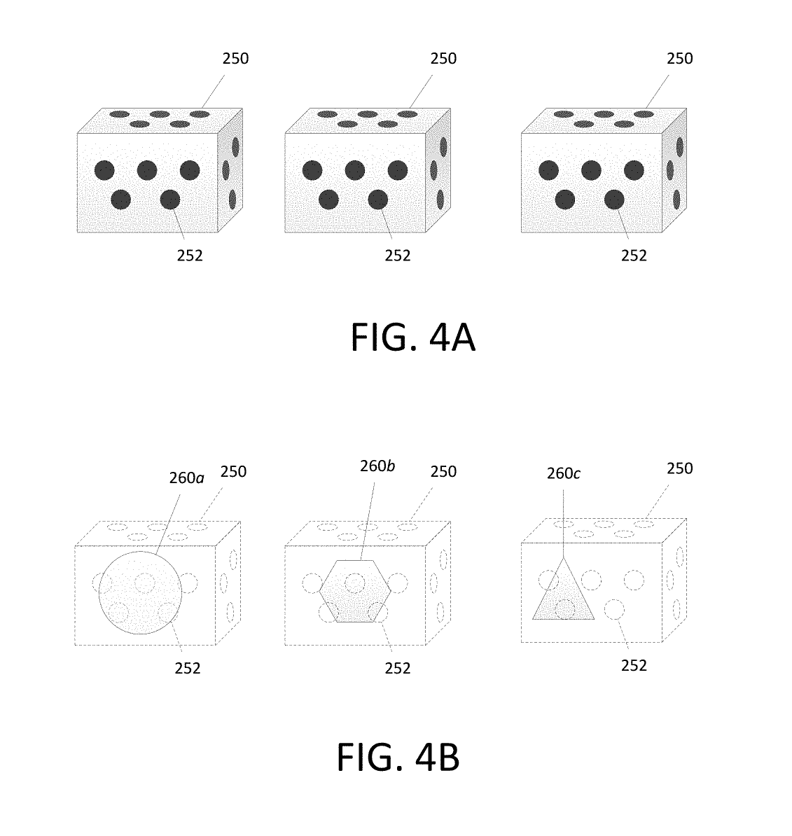

Referring to FIG. 4A and FIG. 4B, the preferred embodiment of the sensor encasement 250 is displayed. The sensor encasement 250 is an external protective casing for holding the sensor 200. The sensor encasement 250 may be made from any type of material. In the preferred embodiment the sensor encasement 250 is a rigid thermoplastic. In other embodiments the sensor encasement 250 is manufactured from metal. The sensor encasement 250 may contain one or more openings 252 to permit the sensor 260 to interact with the environment while the still being protected by the sensor encasement 250.

The sensor encasement 250 also provides a uniform size and shape for each sensor 260, permitting the UAV 300 to be configured in a simple design and easily interact with each sensor 260 regardless of the type, size, and shape of each individual sensor 260. As illustrated in FIG. 4B, each sensor 260a, 260b, and 260c is designed in a different size and shape. Each sensor encasement 250 provides a uniform structure for loading, carrying, and placement by the UAV 300. An additional embodiment is a mechanism within or attached to a sensor encasement 250 that rotates the sensor 260. For instance, a user could rotate the sensor 260 through instructions entered into a client device 110. In this example, the user can adjust the sensor 260, such as changing angles or views of video through a camera. Each sensor 260a, 260b, and 260c may be a different type of sensor and may have a different function. For instance, one sensor 260a may be a visual camera which takes an image of the location surrounding the sensor 260a while another sensor 260b may be a motion sensor which activates when there is motion in the vicinity of the sensor 260b.

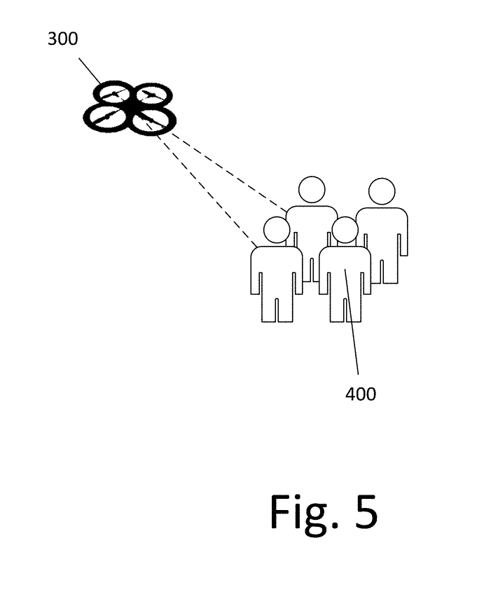

FIG. 5 is an illustration of a portion of the method of the invention. A UAV 300 is present at a particular location. The location may be any physical location in a rural, residential, or urban setting. The location may be a structural location, such as at a building or sporting arena, or at any other public area, such as on a sidewalk or at a park. Alternatively, the location may be a private location. As shown in FIG. 5, the UAV 300 scans or takes an image or a video of an audience 400. The audience 400 may be any number of people. The audience 400 may be a sole individual or a group of people. The audience 400 may be collected together in one location in any density. The audience 400 may be indoors or outdoors. The audience 400 may be seated together and looking in the same direction or may be walking around in different directions. The audience 400 may be in vehicles—such as vehicles traveling a road or highway or stationed in a parking lot or parking garage.

As shown in FIG. 5, the UAV 300 takes a picture or otherwise scans the audience 400. The UAV 300 can then transmit the information to the server 100. The server 100 determines if the size of the audience 400 is sufficient to present a message. Alternatively, the UAV 300 may determine if the size of the audience 400 is sufficient to present a message. In this embodiment the UAV 300 notifies the server 100 of the size of the audience 400 and requests that an appropriate message be sent.

The system may determine the relative size of an audience 400 in many ways. First, the system may have a basis of photographs displaying a known number of individuals. The system may compare an image of an audience 400 to images of known group sizes to determine the closest match. In addition, the system may recognize the form of each individual person in an image and perform a calculation to count each individual. Alternatively, the system may analyze only a portion of an image or scan of an audience 400, determine the specific number of individuals in that portion of the image, and then calculate an average number of individuals for the entire audience by extrapolating the 400 number of portions contained in the entire image or scan of the area. The calculations determining the size of the audience 400 may be performed by the server 100 or the UAV 300.

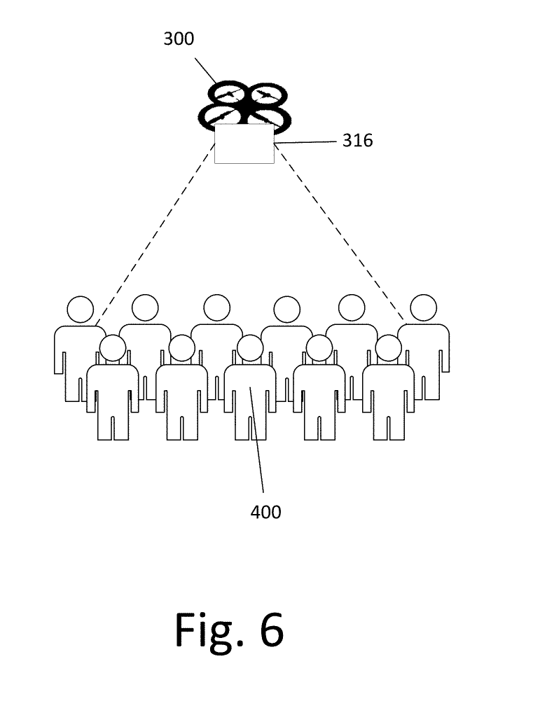

As shown in FIG. 6, once a suitable audience 400 has been identified, the server 100 sends a message for display to the audience 400. The server 100 transmits the message to the UAV 300. The UAV then presents the message to the audience via the display screen 316. If the message contains an audio component then the UAV 300 plays the audio component of the message on the speaker 318 in conjunction with the display on the display screen 316.

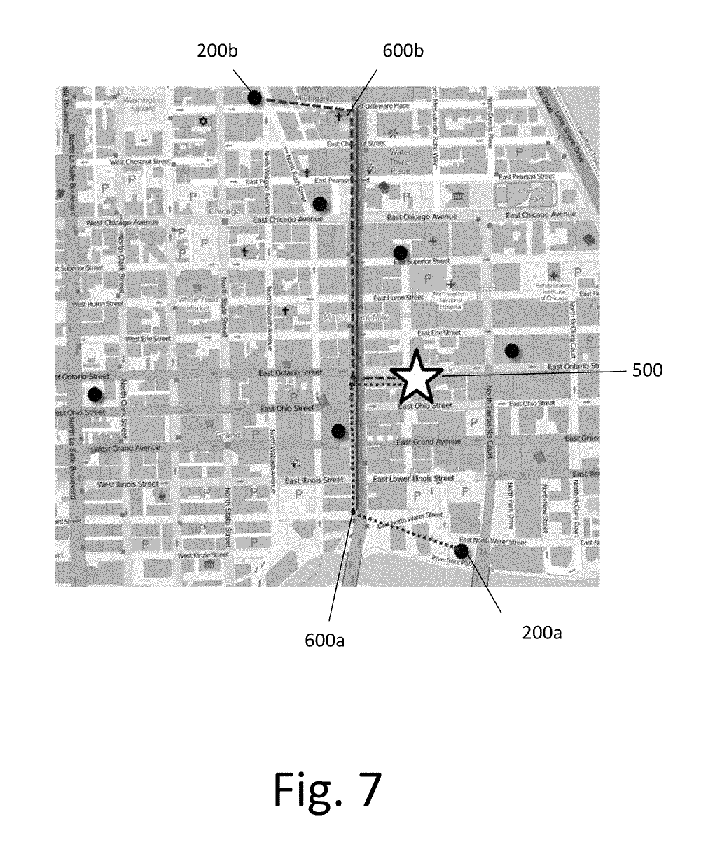

Referring to FIG. 7, a map showing the utilization of the system is illustrated. As shown by FIG. 7, an audience is present at a location 500. The location 500 may be any geographical place in an urban, residential, or rural environment. In the map illustrated, the server 100 is notified about the presence of an audience 400 at the location 500. The server 100 may be notified of the presence of an audience 400 by a UAV 300 or a sensor 260. The server 100 then determines the location of charging stations 200a, 200b that have UAVs 300 which can be sent to the location 500. The server selects the appropriate UAVs 300 at respective charging stations 200a, 200b and calculates the appropriate flight paths 600a, 600b for the respective UAVs 300 to fly to the location 500. The server 100 then transmits appropriate instructions to the respective UAVs 300 which then execute the flight paths 600a, 600b, arrive at the location 500, and displays the chosen message to the audience 400.

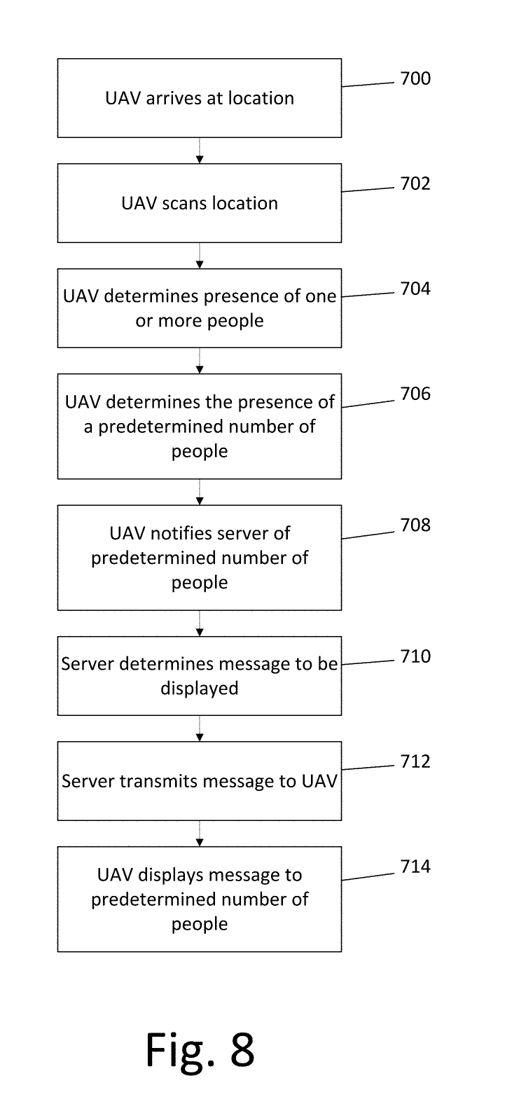

Referring to FIGS. 8-14, the method of the invention is illustrated. As shown in FIG. 8, the UAV first arrives at the location 700. The UAV then scans the location 702. The UAV may scan the location by any known means which would permit the UAV or the server to identify the presence of an audience, such as with a camera, with a motion sensor, with a heat sensor, with an infrared sensor, or any other type of sensor.

The UAV then determines the presence of one or more people 704. In another embodiment the UAV may scan and determine the presence of one or more people through “geo-fencing.” In this manner the UAV creates a virtual geographic boundary within a certain distance from the UAV. The UAV 300 or server 100 may then detect the presence of one or more location-aware devices (such as cellular phones) within the virtual geographic boundary.

Alternatively, the UAV may send information received from the camera or other sensors to the server and the server determines the presence of one or more people. The system may determine the presence of people through software programmed to recognize human shape or facial recognition software. The UAV then determines the presence of a predetermined number of people 706. The predetermined number of people is the number chosen by an operator for a UAV to present a message to an audience. For instance, if the predetermined number of people is ten, then the UAV will not display a message if the number of people present is nine or less. If the predetermined number of people is one, then the UAV will display the message when it recognizes the presence of a person. In other embodiments the server 100 determines the presence of a predetermined number of people.

The UAV then notifies the server of the presence of the predetermined number of people 708. Alternatively, the server determines the presence of the predetermined number of people via the image sent to the server by the UAV. The server then determines the message to be displayed to the audience 710. The server transmits the message to the UAV 712. The UAV then displays the message to the predetermined number of people 714.

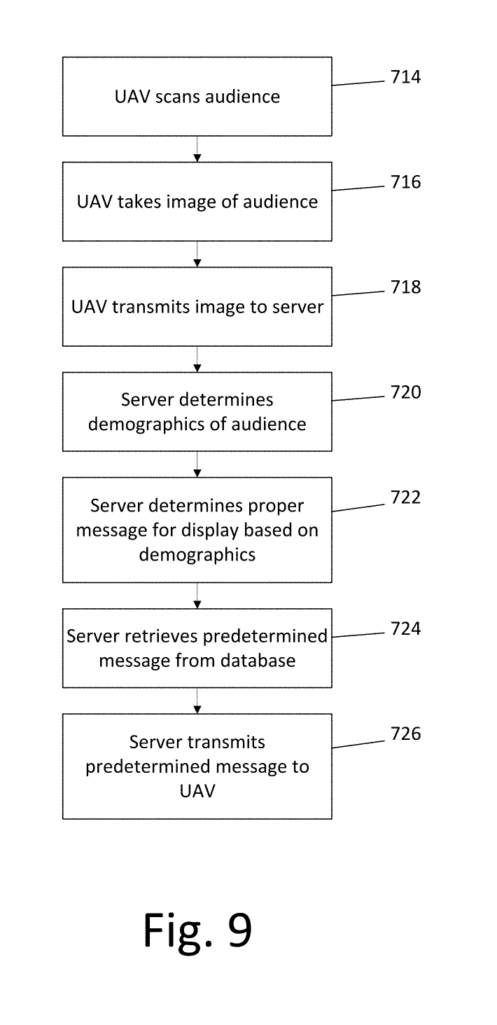

Furthermore, the method of the invention is illustrated by the FIG. 9. As shown, the UAV scans the audience 714. The scan of the audience can be taken prior to displaying a message or after displaying a message. The scan can consist of taking a picture or video of the surrounds or a given area to determine the number of people present. Furthermore, the determination of the audience count can occur locally on the UAV or alternatively, the image/video can be sent to the server to determine the number of people present. The UAV then takes a picture of the audience or otherwise records input received from a sensor about the audience 716. The UAV then transmits the image or recording to the server 718. The server then determines the demographics of the audience 720. Alternatively, the server can use the picture/video captured and sent by the UAV when scanning the audience to determine the number of people present. The demographics measured may include the number of people in the audience, the number of a particular gender that is present, the age range (or subsets of age ranges) of the people present, racial groups, persons paying attention to the UAV or message, or any other selected subset of the audience. The server then determines the proper message to be displayed to the audience based on the measured demographics 722. For instance, if the server determines that the majority of the audience is comprised of children, then the server may select a message advertising a children's television show. The server then retrieves the predetermined message from the database 724. The server then transmits the predetermined message to the UAV 726.

The system may determine the demographics of the audience in a number of ways. To determine the racial make-up of an audience 400 the system may determine the skin color of the separate individuals, assign each individual a value based on the tone or color of an individual's skin, and group those with similar values together. The system may then calculate a percentage for each group as a part of the entire audience 400. Alternatively, the system may have images stored in a database with known racial demographics. The system may compare an image of an audience 400 to images with known racial make-ups to find the image with the closest match. To determine the age demographics of an audience 400 the system may utilize the height of the individuals to determine a relative age for each individual in an image. Those who are shorter are grouped into a younger age category while those who are taller are grouped into an older age category. The height of any specific individual can be determined by the system by triangulation or measuring the angle of inclination and the distance from the UAV 300 to the individual to execute a sine or tangent function and calculate the height of the individual. The system may also attempt to determine the hair color of individuals as well. If the system detects individuals with gray hair then the system will categorize those individuals in an elderly age group. The system may also compare an image of the audience to a group of images in a database containing known age demographics. The system then matches the image to the picture with the closest match and utilizes the known demographics of the matching image. The system may also analyze a small portion of the overall image of an audience 400 and calculate the total based on the number of portions contained in the entire image. The calculations determining the demographic make-up may be performed by the UAV 300 or the server 100.

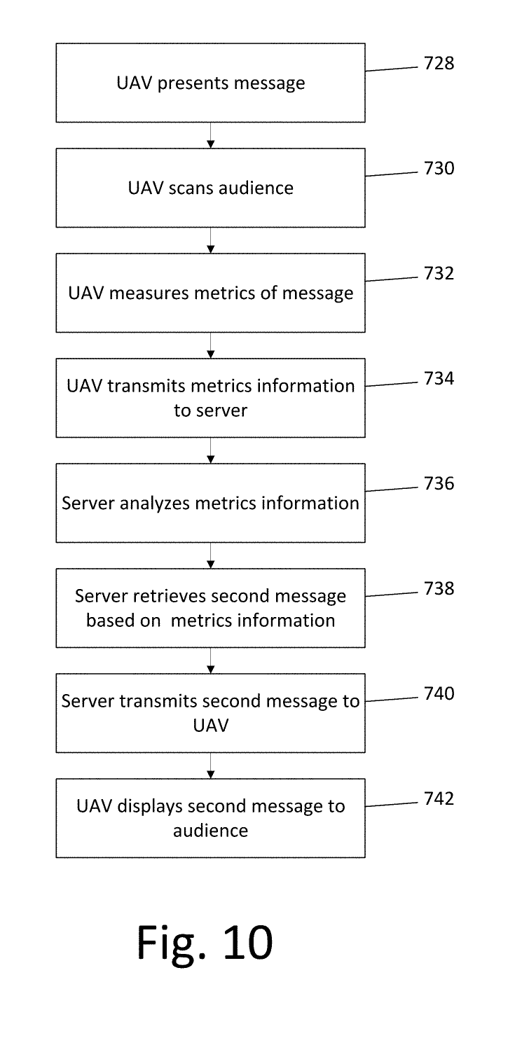

Furthermore, as illustrated in FIG. 10, the UAV presents the selected message to the audience 728. The UAV then scans the audience to determine the audience's reaction to the message 730. The UAV measures the metrics of the message presented 732. The metrics measured may be any sort of metrics pertaining to the audience's engagement with the message. This may include number of people looking directly at the display screen of the UAV, the length of time that the message is displayed on the display screen, or any other metrics. The UAV may measure these metrics through the use of software, such as facial recognition software. In other embodiments the UAV takes measurement of the audience and transmits the information to the server, where the server determines the metrics of the audience's engagement with a particular message. Once the UAV measures the metrics of the message, the UAV then transmits the metrics information to the server 734. The server then analyzes the metrics information to determine trends in audience engagement with the message displayed by the UAV and popularity and successfulness of the message to reach the audience 736. Based upon the analysis of the metrics, the server then retrieves a second message from the database 738. The server then transmits the second message to the UAV 740. The UAV then displays the second message to the audience 742. For instance, if the first message is not connecting with the audience, the server may select a message which is more likely to reach the target audience. Likewise, if the first message is very popular and fully engaged by the audience, the server may select a second message which is highly similar in content to the first message.

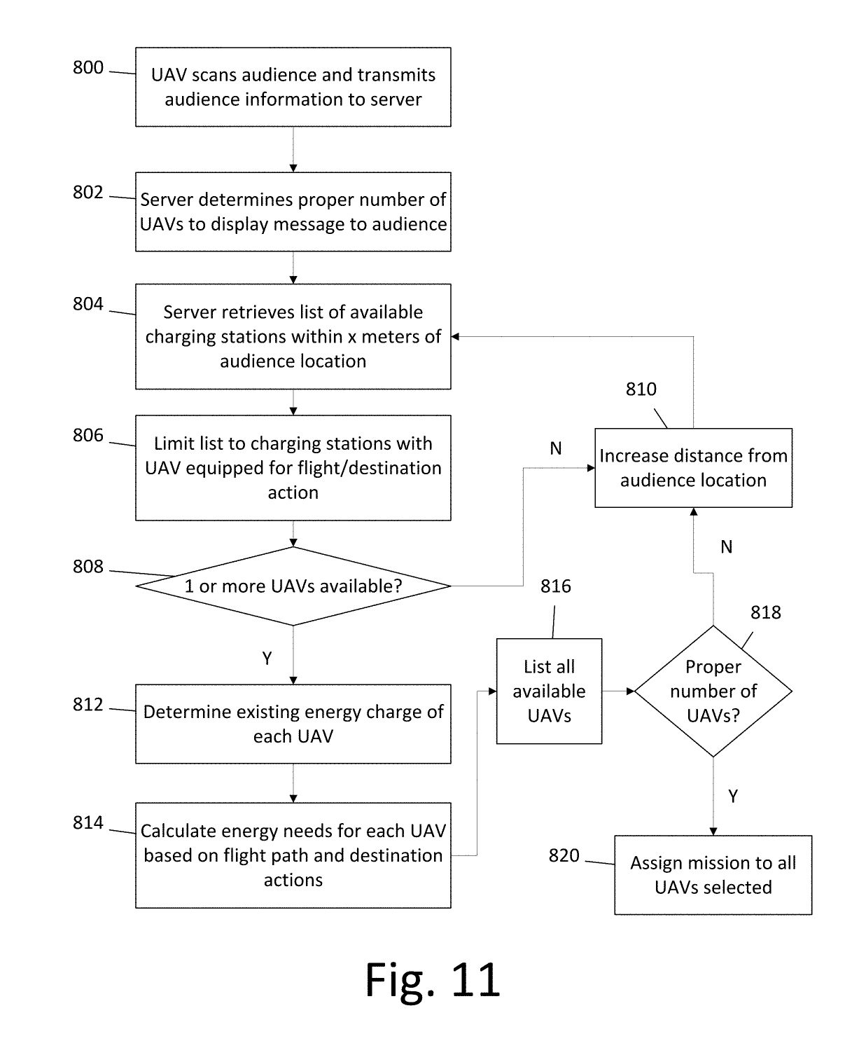

Referring to FIG. 11, an overall method of the system is illustrated. First, the UAV scans the audience and transmits audience information to the server 800. The server then determines the proper number of UAVs needed to display a message to an audience 802. For instance, the server may determine that the audience is small enough that only one UAV is needed to display the message. Alternatively, the server may determine that the audience is fairly large and that ten UAVs are required for a sufficient number of people in the audience sees the message. The server then retrieves a list of all available charging stations within a predetermined distance of the location 804. The server then limits the list of charging stations to those having UAVs equipped to display the message, such as those UAVs having display screens 806. The server then determines whether there are one or more UAVs available 808. If there are not enough UAVs available then the server increases the distance from the audience location and repeats the search 810. Once a sufficient number of UAVs are found then the server determines the energy charge of each UAV 812. The server then calculates the energy needs for each UAV based upon the calculated flight path and the destination actions 814. The system then generates a list of all resulting UAVs which have the appropriate structure and sufficient energy level 816. The server then determines if there are the proper number of UAVs which match the number of UAVs required to display the message 818. If not then the server increases the distance from the audience location and repeats the search 810. Once the system has the appropriate number of UAVs then the server assigns the mission to all of the selected UAVs and transmits the mission instructions to each selected UAV 820. The server may assign the mission and transmit instructions to all UAVs at the same time or may individually transmit instructions to respective UAVs until the required number of UAVs are selected.

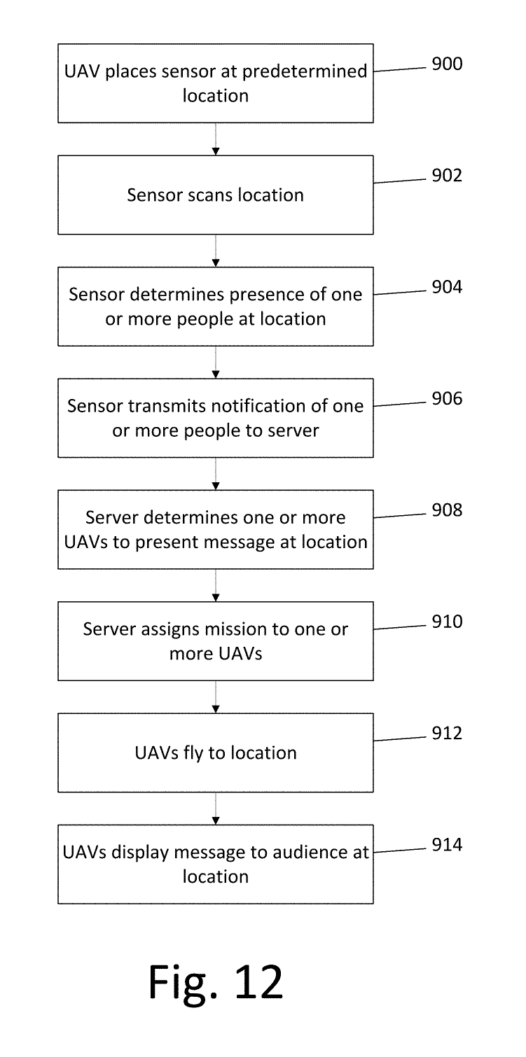

Referring to FIG. 12, the method of utilizing sensors in the method of the invention is illustrated. First the UAV places a sensor at a predetermined location 900. The predetermined location may be any place where an audience is expected. The sensor then scans the location 902. The sensor may scan the location at regular intervals or continuously. Alternatively, the sensor may only be activated at specific times or circumstances. For instance, the sensor may be a camera which takes pictures of the location for determining the presence of people, a heat sensor which determines the presence of body heat from a group of people, or a motion sensor which is activated when people move near the sensor. The sensor then determines the presence of one or more people at a location 904. Alternatively, the sensor transmits information to the server and the server determines the presence of one or more people at the location. The sensor transmits notification of the presence of one or more people to the server 906. The server then determines the location of one or more UAVs available to present a message to the audience at the location 908. The server selects the message for display and assigns the mission to one or more UAVs 910. The selected UAVs then fly to the audience location 912. The UAVs then display the selected message to the audience 914.

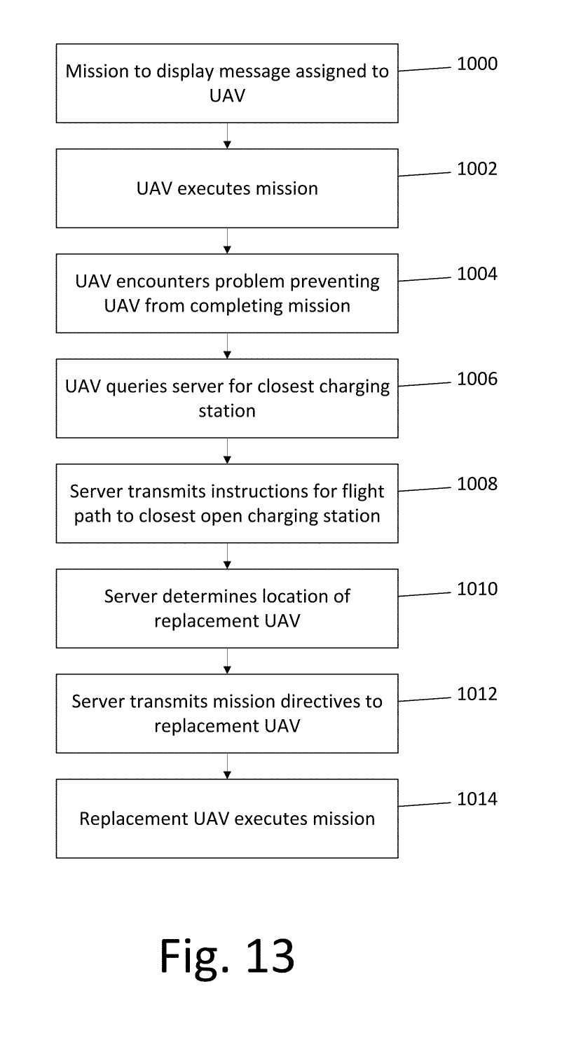

Reviewing FIG. 13, a further method of the invention is illustrated. The mission to display a message is assigned to a UAV 1000. The UAV then begins to execute the mission 1002. The UAV then encounters a problem which prevents the UAV from completing the mission 1004. The problem may be any problem which prevents the completion of the mission, such as inclement weather or loss of power. If possible, the UAV queries the server for the closest charging station 1006. The server then transmits instructions to the UAV for the flight path to the closest open charging station 1008. The server then determines the location of a replacement UAV 1010. The server transmits mission directives to the replacement UAV 1012. The replacement UAV then executes the mission in place of the first UAV 1014.

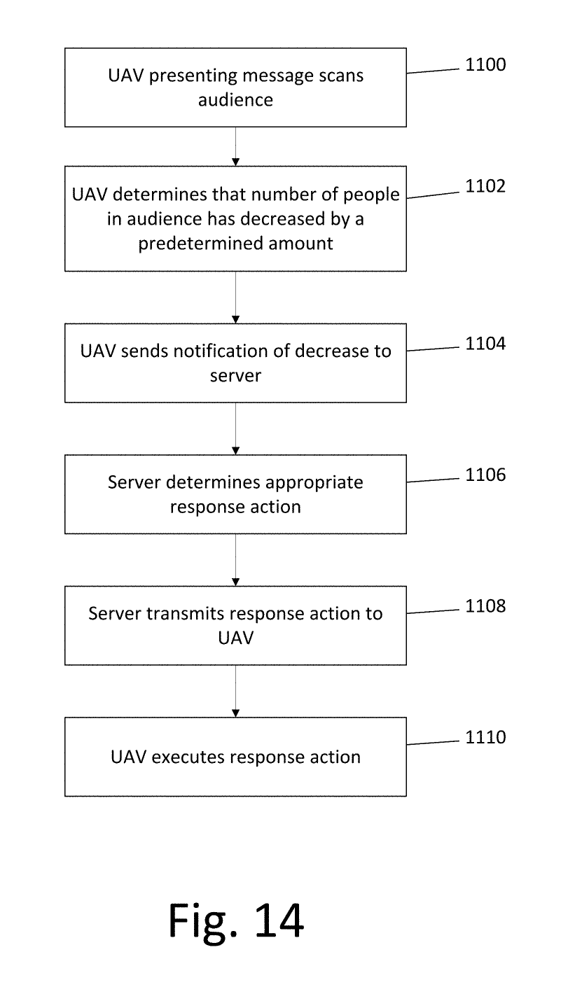

Referring to FIG. 14, the ending of the method of the invention is illustrated. The UAV presenting the message scans the audience during the presentation of the message 1100. The UAV may continuously scan the audience or may scan the audience at regular intervals. The UAV then determines that the number of people in the audience has decreased by a predetermined number 1102. Alternatively, the UAV may send information to the server and the server determines that the audience has decreased by a predetermined number of people. The decrease in number of people may be measured in a specific number of people or percentage of the original size of the audience. The UAV then sends notification of the decrease in the size of the audience to the server 1104. The server then determines the appropriate response action for the UAV 1106. The response action may be for the UAV to leave the location of the audience or display a different message appropriate to the smaller audience. The server then transmits the response action to the UAV 1108. The UAV then executes the response action, such as displaying the new message for the smaller audience or leaving the location of the audience 1110. Alternatively, the response action may be for the UAV to follow a majority of the audience if the audience is moving, such as if the audience is involved in a parade, walk, or 5K run.

The message displayed by the UAV 300 may be a prerecorded message stored in a database 108 on a server 100. Alternatively, the message may be a live streaming video feed which is selected and redirected by the server 100. The server 100 may select a certain prerecorded message based on the demographics of the audience and transmit the prerecorded message to the UAV 300 for display. Additionally, based on information scanned by the UAV 300, the server 100 may determine that a certain live streaming video feed may be better suited to the audience. The server 100 may then select a predetermined live video feed to transmit to the UAV 300 to be displayed. Alternatively, the server 100 may decide to “change the channel” and select an alternative live video stream to display to the audience. The live video feeds may be any audiovisual stream of information and come from any source into the server computer 100, such as from a cable feed or from a satellite broadcast. The feed may also be only an audiosignal, such as a live radio broadcast received by the server computer 100. The server computer 100 may change the message which is selected and transmitted to the UAVs 300 at any time and for any reason—such as switching between live video feeds and prerecorded messages stored on a database. The server 100 may also switch between audiovisual messages, static visual display messages, and audio messages. In the preferred embodiment the live video feed is segmented into a series of message data files which are continuously transmitted to the UAV 300.

The system may be utilized in many separate ways. For instance, a UAV 300 may fly down a public sidewalk in an urban setting. The UAV 300 may take a picture of a face of a person walking on the sidewalk. The UAV 300 can then transmit the image to the server 100. The server 100 may then run a facial recognition program against a database of users to determine the identity of the person. Once the server 100 determines the identity of the person the server 100 may search the database 108 for a message which is appropriate for the identified person. The server 100 then selects the appropriate message and transmits it to the UAV 300. The UAV 300 then displays the message on the display screen 316 to the person.

In another embodiment of the invention a person may hold out a visual input which is recorded by the UAV 300. The visual input may be any type of visual signal or sign. For instance, the visual signal may be a QR code or a bar code. The UAV 300 then scans the QR code or bar code with a camera and sends the information to the server 100. The server 100 may then determine the proper response which is stored in the database 108 that properly corresponds to the visual input presented by the person. The server 100 then selects the appropriate message and transmits it to the UAV 300. The UAV 300 then displays the message on the display screen 316 to the person.

In another utilization the UAV 300 may fly along a highway and detect the presence of a sizable number of cars traveling on the highway which would constitute an audience. The UAV 300 notifies the server 100 of the audience. The server 100 may determine the location of the UAV 300 along the highway and determine that an accident has occurred on the highway five miles ahead of the UAV 300. The server 100 then selects a notification message to transmit to the UAV 300, such as “CAUTION: ACCIDENT AHEAD.” The server 100 then transmits the message to the UAV 300. The UAV 300 then displays the message “CAUTION: ACCIDENT AHEAD” on the display screen 316 to cars traveling along the highway.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module, which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1) A computer implemented method for executing a flight mission by one or more unmanned aerial vehicles to be performed on a computer system comprising two or more microprocessors and two or more nonvolatile memory units wherein at least one of said two or more microprocessors and one of said two or more nonvolatile memory units is integral to an unmanned aerial vehicle further comprising a flight means and a display screen, said two or more nonvolatile memory units storing instructions which, when executed by said two or more microprocessors, cause said computer system to perform operations comprising
a) receiving, from a first unmanned aerial vehicle at an audience location, a data stream containing audience location information;
b) analyzing said audience location information to determine the presence of one or more people at said audience location;
c) receiving an instruction setting a predetermined number of people;
d) determining whether a number of people at said location is equal to or greater than said predetermined number of people;
e) retrieving a message data file;
f) transmitting said message data file to said first unmanned aerial vehicle;
g) displaying, by said first unmanned aerial vehicle, said message data file on a display screen integral to said first unmanned aerial vehicle.

2) The computer implemented method as in claim 1 further comprising determining demographic information of one or more people at said location.

3) The computer implemented method as in claim 2 further comprising
a) determining an appropriate second message file based on said demographic information;
b) retrieving a second message data file;
c) transmitting said second message data file to said first unmanned aerial vehicle;
d) displaying, by said first unmanned aerial vehicle, said second message data file on a display screen integral to said first unmanned aerial vehicle.

4) The computer implemented method as in claim 1 further comprising performing, by said first unmanned aerial vehicle, a scanning method on one or more people during a period of time, wherein said scanning method is selected from a group consisting of:
a) taking a picture of one or more people with a camera integral to said first unmanned aerial vehicle;
b) detecting motion within a predetermined distance of said first unmanned aerial vehicle by means of a motion sensor integral to said first unmanned aerial vehicle;
c) detecting body heat of one or more people with an infrared sensor integral to said first unmanned aerial vehicle; and
d) creating a virtual geographic boundary a predetermined distance from said first unmanned aerial vehicle and detecting the presence of one or more location-aware devices within said virtual geographic boundary.

5) The computer implemented method as in claim 1 further comprising determining one or more metrics for a message displayed by said first unmanned aerial vehicle, wherein said one or more metrics is selected from a group comprising: a number of people viewing said first unmanned aerial vehicle, a gender of one or more people viewing said first unmanned aerial vehicle, an age of one or more people viewing said first unmanned aerial vehicle, an age range of two or more people viewing said first unmanned aerial vehicle, and a time period during which a message is displayed on said first unmanned aerial vehicle.

6) The computer implemented method as in claim 1 further comprising
a) receiving a visual input from a person at said audience location;
b) creating a visual input data file; and
c) transmitting said visual input data file from said first unmanned aerial vehicle to a server computer.

7) The computer implemented message as in claim 1 further comprising broadcasting an audio file through a speaker integral to said first unmanned aerial vehicle.

8) The computer implemented method as in claim 1 further comprising
a) scanning, with a camera integral to said first unmanned aerial vehicle, at least a portion of a face of a person;
b) creating a facial image file;
c) comparing said facial image file to a set of previously stored reference files, wherein each of said reference files comprises facial characteristic information of one or more people; and
d) determining a match between said facial image file and said reference file.

9) The computer implemented method as in claim 8 further comprising
a) determining an appropriate second message file based on information contained in a reference file which matches said facial image file;
b) retrieving a second message data file;
c) transmitting said second message data file to said first unmanned aerial vehicle;
d) displaying, by said first unmanned aerial vehicle, said second message data file on a display screen integral to said first unmanned aerial vehicle.

10) The computer implemented method as in claim 1 further comprising
a) determining an appropriate number of unmanned aerial vehicles to display said message data file to a number of people at said audience location;
b) determining a location of one or more second unmanned aerial vehicles;
c) respectively determining one or more geographic flight paths for said one or more second unmanned aerial vehicles
i) wherein each of said one or more geographic flight paths includes a starting point, said starting point being a location of a second unmanned aerial vehicle, and a geographic ending point, said geographic ending point being said audience location; and
d) transmitting flight path instructions to said one or more second unmanned aerial vehicles.

11) A computer implemented method for executing a flight mission by one or more unmanned aerial vehicles to be performed on a computer system comprising two or more microprocessors and two or more nonvolatile memory units wherein at least one of said two or more microprocessors and one of said two or more nonvolatile memory units is integral to an unmanned aerial vehicle further comprising a flight means and a display screen, said two or more nonvolatile memory units storing instructions which, when executed by said two or more microprocessors, cause said computer system to perform operations comprising
a) scanning, by an unmanned aerial vehicle, one or more people at an audience location;
b) creating, by said unmanned aerial vehicle, a scan data file;
c) transmitting, by said unmanned aerial vehicle, said scan data file to a server computer;
d) receiving, by said server computer, said scan data file;
e) analyzing information contained in said scan data file;
f) selecting, by said server computer, a message data file;
g) transmitting, by said server computer, said message data file to said unmanned aerial vehicle; and
h) displaying, by said first unmanned aerial vehicle, said message data file on a display screen integral to said first unmanned aerial vehicle.

12) The computer implemented method as in claim 11 further comprising determining demographic information of one or more people at said audience location.

13) The computer implemented method as in claim 12 further comprising
a) determining an appropriate second message file based on said demographic information;
b) retrieving a second message data file;
c) transmitting said second message data file to said unmanned aerial vehicle;
d) displaying, by said unmanned aerial vehicle, said second message data file on a display screen integral to said unmanned aerial vehicle.

14) The computer implemented message as in claim 11 further comprising broadcasting an audio file through a speaker integral to said unmanned aerial vehicle.

15) The computer implemented method as in claim 11 wherein the step of scanning is selected from a group consisting of:
a) taking a picture with a camera integral to said unmanned aerial vehicle;
b) detecting motion within a predetermined distance of said first unmanned aerial vehicle by means of a motion sensor integral to said unmanned aerial vehicle;
c) detecting body heat of one or more people with an infrared sensor integral to said unmanned aerial vehicle; and
d) creating a virtual geographic boundary a predetermined distance from said unmanned aerial vehicle and detecting the presence of one or more location-aware devices within said virtual geographic boundary.

16) The computer implemented method as in claim 11 further comprising determining one or more metrics for a message displayed by said unmanned aerial vehicle, wherein said one or more metrics is selected from a group comprising: a number of people viewing said first unmanned aerial vehicle, a gender of one or more people viewing said first unmanned aerial vehicle, an age of one or more people viewing said first unmanned aerial vehicle, an age range of two or more people viewing said first unmanned aerial vehicle, and a time period during which a message is displayed on said first unmanned aerial vehicle.

17) A computer implemented method for executing a flight mission by one or more unmanned aerial vehicles to be performed on a computer system comprising two or more microprocessors and two or more nonvolatile memory units wherein at least one of said two or more microprocessors and one of said two or more nonvolatile memory units is integral to an unmanned aerial vehicle further comprising a flight means and a display screen, said two or more nonvolatile memory units storing instructions which, when executed by said two or more microprocessors, cause said computer system to perform operations comprising
a) receiving, by an unmanned aerial vehicle, visual input information from one or more people;
b) creating, by said unmanned aerial vehicle, an image data file;
c) transmitting, by said unmanned aerial vehicle, said image data file to a server computer;
d) analyzing, by said server computer, said image data file to determine said visual input information;
e) determining, by said server computer, a predetermined response message to said visual input information;
f) selecting, by said server computer, a message data file;
g) transmitting, by said server computer, said message data file to said unmanned aerial vehicle; and
h) displaying, by said first unmanned aerial vehicle, said message data file on a display screen integral to said first unmanned aerial vehicle.

18) The computer implemented method as in claim 17 further comprising determining, by said server computer, that said visual input information comprises a QR code.

19) The computer implemented method as in claim 17 further comprising determining, by said server computer, that said visual input information comprises at least a portion of a person's face.

20) The computer implemented message as in claim 17 further comprising broadcasting an audio file through a speaker integral to said unmanned aerial vehicle.
